(19) United States
(12) Patent Application Publication
(10) Pub. No.: US 2026/0233961 A1
(43) Pub. Date: Aug. 13, 2026

(54) AN ARRANGEMENT FOR ARRANGING NUMBER OF FILAMENTS TO A BUNDLE AND A METHOD THEREOF

(71) Applicant: SPINNOVA OYJ, Jyväskylä (FI)

(72) Inventors: Markko MYLLYS, Jyväskylä (FI); Pasi SELENIUS, Jyväskylä (FI); Juha SALMELA, Jyväskylä (FI)

(21) Appl. No.: 19/155,048

(22) PCT Filed: Jan. 30, 2024
(86) PCT No.: PCT/FI2024/050036

§ 371 Date: Aug. 8, 2025

(30) Foreign Application Priority Data
Feb. 8, 2023 (FI) 20235125

(51) Int. Cl. B65H 51/16; B65H 51/005; D01G 23/08

(52) U.S. Cl. CPC B65H 51/16; B65H 51/005; D01G 23/08

(57) ABSTRACT

An arrangement for arranging number of filaments transferred by a transferring device to at least two separate subsets of said filaments comprises at least one fluid flow providing device for providing fluid flow towards at least one portion of the filaments transferred by a transferring device, thereby deflecting a path of said portion of the filaments in a second direction differing from a first direction said filaments being transferred by said transferring device The filaments are thus separated to at least two filament subsets of the filaments. The filament subsets may then be arranged to at least two separate and advantageously separately reopenable bundles.

### TECHNICAL FIELD OF THE INVENTION

The invention relates to an arrangement and a method for arranging number of filaments. In particularly, the invention relates to an arrangement and a method for arranging number of filaments to a bundle.

### BACKGROUND OF THE INVENTION

A system for providing filaments from a wet suspension is known, where the suspension is fed through number of nozzles to provide filaments onto a surface in an input area of a transferring device, such as a belt conveyor or rotating cylinder. Typically, a large-scale system comprises more than 3500 nozzles and thus essentially as many filament lines on the surface of the transferring device. The transferring device is used both for transferring the filaments from the input area to an output area, but also heat and dry the filaments during the transferring, because the filaments received onto the input area of the transferring device are wet due to the wet suspension extruded thought the nozzles.

When the filaments are heated, they will dry by the output area and the dried filaments are then guided to a further process, such as to a winding device, which winds the filaments to a continuous filament bundle, which is a precursor of yarn or string. The yarn or string is again used for manufacturing textiles.

There are some problems related to the further process of the filament bundle coming from the output of the transferring device, namely when it is winded, the winded continuous filament bundle cannot be opened anymore to smaller size bundles, because the filaments are tangled to each other in the bundle. In addition, the winded continuous filament bundle comprises around 3500 filaments, or even more, depending on the number of the nozzles, which is far too big for many any additional further process, such as for making yarns. As an example, the yarn used for the finest textiles has less than 100 filaments in the yarn and the yarn count is smaller than 5 g/10 km or even smaller than 2 g/10 km or even less. Thus, the bundle must have been broken smaller and again numerous intermediate stages have been needed to achieve a desired size bundle. This naturally increases time and energy consumption to get the desired size bundle, as well as make an entire system complicated.

### SUMMARY OF THE INVENTION

An object of the invention is to alleviate and eliminate the problems relating to the known prior art. Especially the object of the invention is to provide an arrangement and method for arranging number of filaments so that a bundle achieved from the arranged filaments would be a desired size e.g. in yarn counts and so that there would be no further needs to manipulate the bundle to achieve the desired yarn count for the bundle.

The object of the invention can be achieved by the features of independent claims.

The invention relates to an arrangement for arranging number of filaments according to claim 1. In addition, the invention relates to a method for arranging number of filaments according to claim 16.

According to an embodiment of the invention an arrangement for arranging number of filaments comprises a transferring device for receiving the filaments to a surface of the transferring device in an input area from multiple outputs, such as nozzles. The system typically comprises more than 3000, advantageously more than 3500 material outputs or nozzles to provide essentially as many filaments, and thus essentially as many filament lines on the surface of the transferring device. It is to be noted that the number of the nozzles are not limited to those numbers only but may advantageously comprise also larger number of nozzles and thus filament lines. The filament lines are paths the filaments are travelling at least at the beginning or just from the input area in a first direction.

The transferring device transfers the filaments from the input area to an output area in the first direction and again to a further process, such as a folding or winding process of said filaments by a winding device. According to an embodiment of the invention the arrangement comprises at least one fluid flow providing device for providing fluid flow towards at least one portion of the filaments transferred by the transferring device. The fluid flow then deflects a path of the portion of the filaments in a second direction differing from or being perpendicular (or at least a component being perpendicular) to the first direction, thus separating the portion to a subset from the rest of the filaments transferred. In this way the arrangement is configured to provide at least two subsets. The two subsets can then be manipulated or arranged to two separate bundles of continuous filaments for the further process of the filaments.

The continuous filament means here the filament, which length is at least the length of the transferring device between the input and output areas, but may naturally be also much more longer. In theory, the length of the continuous filament may be as long there is enough material coming from the material output to the input area of the transferring device and how long the transferring device is transferring the filament and what is the further process of the filament.

Naturally, the arrangement may comprise numbers of the fluid flow providing devices for providing numbers of the fluid flows and thus providing numbers of subsets of the filaments. According to an advantageous embodiment, the fluid flow providing devices are arranged sequentially in the first direction so that they do not to disturb each other's fluid flows and thus separation of the filaments to the subsets. The fluid flow providing devices are configured to arrange number of portions of said filaments to number of the subsets so that one subset has a certain number of filaments at maximum so to achieve bundle with a certain number of filaments at maximum. According to an advantageous embodiment of the invention, even if there would be more than 3000+ material outputs or nozzles providing 3000+ filaments, the subsets and bundles with less than 300 filaments, more advantageously less than 200 filaments and most advantageously 150 or 100 filaments at maximum can be achieved.

The using of the fluid flows for arranging the filaments to the separate subsets is very advantageous, namely there is no need for any mechanical deflectors or separators, which typically causes disturbances, such as getting thin and light filaments to be tangled to the mechanical structures. The fluid flows do not have this disadvantage. In addition, fluid flows can be controlled accurately, such as angle of attack or velocity of the fluid flow, thereby controlling the separation efficiency of the filaments to the separate subsets. In addition, the fluid flow can also control the path of the filaments very accurately and in a desired way e.g. compared to mechanical deflectors, namely the fluid flow gives an impact to the filaments so that the filaments tend to continue their path to the direction induced by the fluid flow. It has been noticed that without the fluid flow controlling according to the invention, the tiny and very light filaments may easily float to and in an air current around the devices, namely there are almost always some kind of air currents due to moving transferring device and temperature differences, for example.

Furthermore, the invention offers clear advantage, namely the bundles can be achieved from the continuous filaments and so that the yarn count of the bundles is a desired fine level, e.g. 5 g/10 km, 2 g/10 km or the like, whereupon the bundle as such can be used directly for making a yarn, for example, and there is no need for numerous intermediate measures, such as stapling the fibres or filaments of the bundle. In addition, it is to be noted that the separate bundles can be different sizes, and the fluid flow providing devices can be arranged so that the number of filaments in different subsets varies and thus also the yarn counts of the different bundles deviate from each other. According to the invention this can be done e.g. controlling the outputs of the fluid flow providing devices, like closing a portion of the outputs of the certain fluid flow providing device. Advantageously, the fluid flow providing device may comprise e.g. suitable valves or the like for opening and closing a certain portion of its outputs, or the opening and closing may also be implemented manually.

Still, it is to be understood, that the material outputs may output the filaments to the input area of the transferring device with different features, such as thickness, receipt or chemical composition, or post treatment agent, whereupon the fluid flow providing devices 108 can be used to separate those filaments with differing features to separate filament subsets, correspondingly. Again, the separate filament subsets with the filaments with differing features can then be collected and guided to provide them again to separate bundles, whereupon each bundle may comprise filament subset with a certain feature.

In addition, the arrangement may also comprise collecting devices for collecting and guiding each of the filament subsets to the separate bundles. The bundles are again guided from the collecting devices to a further processing, such as to the winding device. The number of the filament subsets, collecting devices and at the same the number of the bundles are depended on the needs, so for example the finer quality or smaller number of filaments in a one yarn or smaller yarn count is desired and greater number of the filament subsets, collecting devices and the bundles are required. The collecting device may comprise additionally a pressure manipulating device for decreasing pressure in the collecting device and thereby causing a sucking effect separately for each of the separate filament subsets from the output area after the fluid flow providing devices. The pressure manipulating device is advantageously an ejector. By this the filament subsets separated by the fluid flow providing device(s) can be effectively collected from the surface of the transferring device to inputs of the collecting devices and in addition accelerate the transferring speed of the filaments or bundles through the collecting devices.

The present invention offers clear advantages, such as an accurate, effective, and contactless way to arrange filaments so that e.g. tangling of the filaments to the structures or mechanical deflectors or floating the filaments in an uncontrolled manner can be avoided or at least minimized. In addition, the invention allows to arrange the filaments to desired size filament subsets and again to desired size bundles, which has the advantages already disclosed elsewhere in this document. Advantageously, the bundles are separate and separately openable bundles, which can be used directly for further process, such as to winding or folding process or even directly for manufacturing yarn with suitable and desired yarn count without any additional intermediate measures, such as e.g. stabling. In addition, the adjustment of the arrangement of the invention is easy, when the fluid flow providing device and its outputs can be adjusted or controlled easily, as is depicted in this document.

The exemplary embodiments presented in this text are not to be interpreted to pose limitations to the applicability of the appended claims. The verb “to comprise” is used in this text as an open limitation that does not exclude the existence of also unrecited features. The features recited in depending claims are mutually freely combinable unless otherwise explicitly stated.

The novel features which are considered as characteristic of the invention are set forth in particular in the appended claims. The invention itself, however, both as to its construction and its method of operation, together with additional objects and advantages thereof, will be best understood from the following description of specific example embodiments when read in connection with the accompanying drawings.

### BRIEF DESCRIPTION OF THE DRAWINGS

Next the invention will be described in greater detail with reference to exemplary embodiments in accordance with the accompanying drawings, in which:

FIG. 1 illustrates a side view of an exemplary arrangement for arranging number of filaments to subsets and separate reopenable bundles according to an advantageous embodiment of the invention,

FIG. 2 illustrates a top view of an exemplary arrangement for arranging number of filaments to subsets and separate reopenable bundles according to an advantageous embodiment of the invention,

FIG. 3 illustrate examples of a fluid flow providing device according to an advantageous embodiment of the invention, and

FIG. 4 illustrate a top view of exemplary arrangement with number of fluid flow providing devices for arranging number of filaments to number of subsets and number separate reopenable bundles according to an advantageous embodiment of the invention.

### DETAILED DESCRIPTION

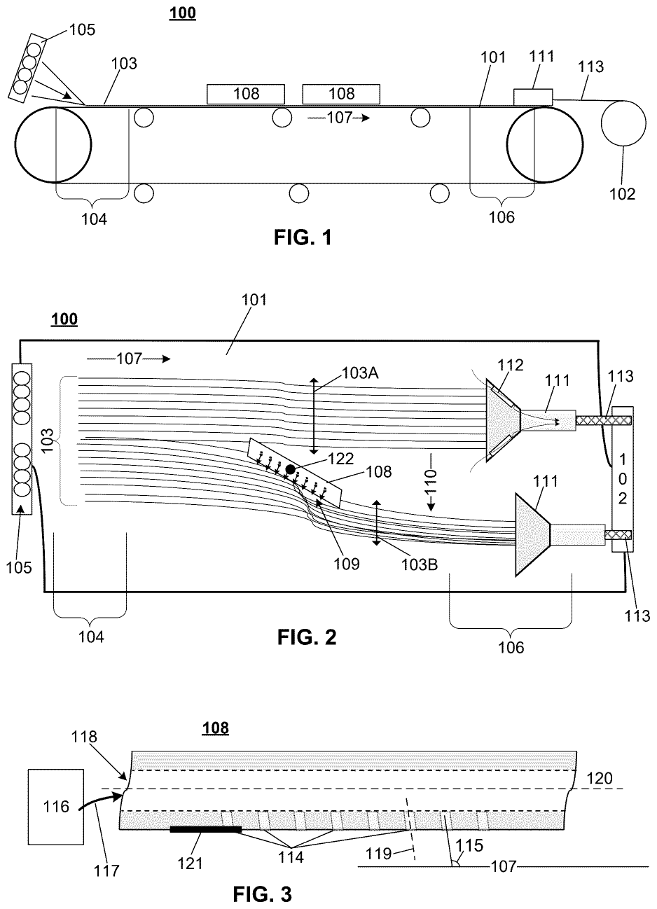

FIG. 1 illustrates a side view and FIG. 2 a top view of an exemplary arrangement 100 for arranging number of filaments 103 to subsets 103A, 103B and again to separate bundles 113 according to an advantageous embodiment of the invention. The bundles are advantageously separately reopenable (separately from each other) and the bundle can be reopened to essentially to the size it was winded. Thus, also the reopenable and reopened bundle comprises the same number of continuous filaments as the bundle provided by the guiding device and thus the bundle winded, for example. The arrangement comprises a transferring device 101 for receiving the filaments 103 to a surface of the transferring device 101 in an input area 104 from multiple outputs 105, such as nozzles. The transferring device 101 illustrated in Figures is a belt conveyor type device, but also other types of transferring devices can be used, such as a rolling cylinder for example.

The transferring device 101 transfers the filaments from the input area 104 to an output area 106 in a first direction 107. The arrangement 100 comprises also one or more fluid flow providing devices 108 for providing fluid flow 109 towards at least one portion of the filaments 103 on the surface of the transferring device 101. The fluid flow providing devices 108 are advantageously arranged between the input 104 and output 106 areas.

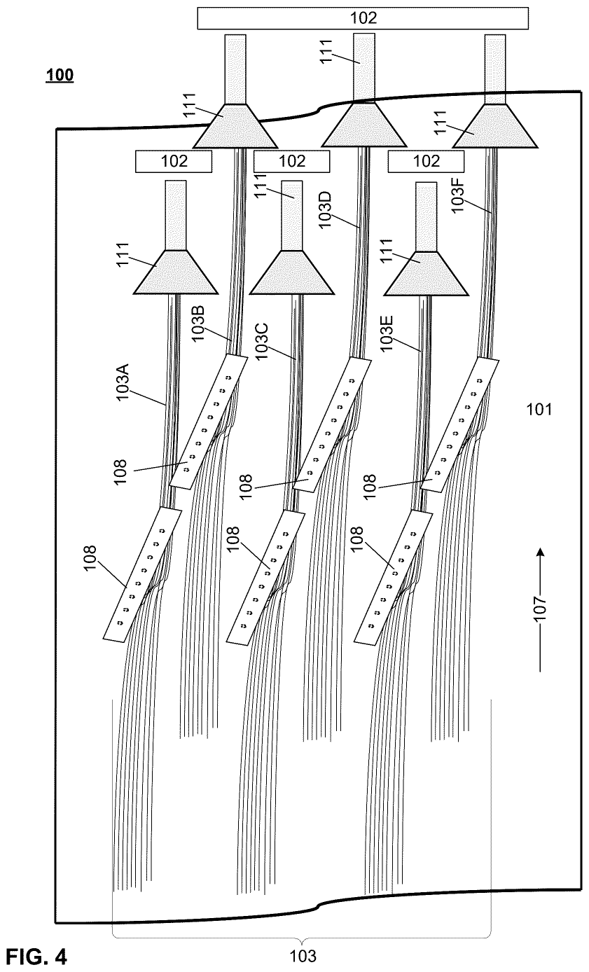

An angle of attack of the fluid flow 109 towards the filaments 103 can be adjustable but is advantageously arranged so that the fluid flow 109 deflects path of the filaments in a second direction 110, which is perpendicular to the first direction 107. In this way the portion of the filaments 103 is separated to a subset 103B and the rest of the filaments 103 is left to another subset 103A, thereby providing at least two subsets and again two separate bundles 113 of continuous filaments for the further process of the filaments. FIG. 2 illustrates an example having one fluid flow providing device 108, but e.g. in FIG. 4 an example with six fluid flow providing devices 108 is illustrated, where the arrangement provides also six subsets 103A-103F. As can be seen in FIG. 4, the fluid flow providing devices 108 are arranged sequentially in the first direction 107.

The arrangement may also comprise collecting devices 111 for collecting and guiding each of the filament subsets 103A-103F to the separate bundles 113. The bundles 113 are again guided from the collecting devices 111 to a winding device 102. It is to be noted that the winding device 102 is an optional and the winding is just an example of the further process of the bundles, and that the winding device 102 can be replaced e.g. by a folding machine (not shown in Figures). The collecting device 111 may also comprise a pressure manipulating device 112 for decreasing pressure in the collecting device 111 and thereby causing a sucking effect separately for each of the separate filament subsets 103A-103F from the output area 106 after the fluid flow providing devices 108. According to an example, the pressure manipulating devices 112 can be controllable independently of each other, thus providing different and unequal sucking effects separately for each of the separate filament subsets.

The arrangement may also comprise one winding device 102 common for all the collecting devices 111 and bundles 113 or the separate winding device 102 for at least one collecting device 111 and bundle 113. If separate winding devices 102 are used, the winding devices 102 can be controlled independently so that for example separate bundles 113 are winded with different rotational speed of the winding devices 102, whereupon e.g. different tensions for the different bundles 113 can be achieved, if needed.

An example of the fluid flow providing device 108 is illustrated in FIG. 3. The fluid flow providing device may comprises a pipe with an input 118 for receiving fluid flow 117, one or more outputs 115, and an inner fluid conduit from the input 118 to the outputs 114. The outputs 114 may be implemented e.g. by capillary tubes extending from the pipe and/or by capillary holes extending from the conduit and through a pipe wall to an outer surface of the pipe. As an example, the outputs may be arranged e.g. in every 1-5 cm, advantageously around every 2 cm along the pipe. The pipe may have e.g. a relatively thick wall (compared to the diameter of the holes), whereupon the holes can be manufactured so that they have accurate focusing effect, for example. In addition, the holes or capillary tubes (or the longitudinal axis 119 of those) may be arranged in a certain angle 115 in relation to a longitudinal axis 120 of the pipe, such as 15° to 45°. However, it is to be noted that the angle of attack is independent of the angle of the capillary tubes or holes in relation to the longitudinal axis of the pipe and the angle of attack is determined by the position of the fluid flow providing device in relation to the transferring device and the filaments transferred.

The output 114 of the fluid flow providing device 108 may have an inner diameter of 0,5-5 mm, advantageously 0,8-2 mm, and most advantageously 0,8-1,0 mm. This offers clear advantages, namely when the inner diameter is in the above-mentioned range, the focus of the high-speed fluid flow is very accurate, as well as the speed of the high-speed fluid flow can be kept very high. In addition, when the inner diameter is in the above-mentioned range, also the diameter of the high-speed fluid flow is small compared to the operational scale, and thus very accurate and specific controlling of the path can be done. Moreover, when the diameter of the high-speed fluid flow is small, the volume flow and thus the consumption of the fluid used for the high-speed fluid flow can be kept at a very low level, but also the sharp high-speed fluid flow does not interfere the environment of the material, the path of which is to be under controlling. Therefore, the overall system is very effective but energy efficient.

Still, when the volume flow is quite low, also the momentum of the high-speed fluid flow is relatively low, whereupon the speed of the high-speed fluid flow decreases fast, and again the speed of the high-speed fluid flow is smaller than the speed of the filaments at 10 cm, more advantageously 20 cm and most advantageously 50 cm from the output of the fluid flow providing device. Here the speed of the filaments is the speed induced by the moving transferring device, which also transfers the filaments.

It is to be noted that according to the invention the volume flow, and thus also the momentum of the high-speed fluid flow, can be controlled e.g. by controlling the velocity or density of the high-speed fluid flow, for example.

The output may just be implemented by a uniform capillary tube or hole with essentially constant diameter, or the output may have a varying inner diameter. The output may be implemented also e.g. by a nozzle type structure, such as a compressed air nozzle. The nozzle may comprise e.g. a conical inner structure so that the inner diameter of the nozzle narrows towards the flow direction. Thus, the nozzle can be used for example for controlling the direction and/or speed of the fluid flow more accurately. In addition, the direction of the output may be controllable, for example manually or the output may be provided by a microcontroller so to change the direction.

Further, the arrangement may comprise outputs with different diameters. According to an example, the smaller diameter outputs are arranged in a downstream direction of the travel of the transferring device and the greater diameter outputs are arranged in an upstream in the direction of the travel of the transferring device. This offers bigger changes to the path of the filaments especially in the upstream and more accurate controlling to the downstream, but naturally the system can be arranged in opposite way if needed. In addition, the smaller diameters in the downstream portion can cause increasing velocity gradient in the direction of the travel and thus e.g. a stretching effect to the filaments, if needed.

Furthermore, according to an embodiment, the high-speed fluid flow can also be used as a carrier flow fluid for additives, such as ions, plasma, additives, dyes and/or functional additives or other additives. This offers additional advantage, namely the material can be manipulated in a controlled manner by the additives, but at the same the additives can be guided in a controlled manner to the same location as the material, such as filaments, are transferred.

The speed of the high-speed fluid flow is, according to an example, configured to be higher than a transferring speed of the material by the transferring device in the first direction 107. In this example a velocity gradient of the high-speed fluid flow is configured to induce a force dragging the filaments towards a maximum of said velocity gradient and thereby change the path of the filaments in a desired manner. Thus, a very accurate controlling of the paths of the filaments and thus arranging of the filaments can be achieved. In addition, the velocity gradient of high-speed fluid flow may also cause compressing of the material, such as filaments, closer to each other or towards the maximum of the velocity gradient of the high-speed fluid flow, which might be desired phenomena in some certain applications.

As disclosed elsewhere in this document, the arrangement may comprise numbers of the fluid flow providing devices, and in addition the fluid flow providing device may also comprise one or more outputs to provide and focus numbers of the high-speed fluid flows towards the filaments or portion of the filaments. In addition, according to an example the initial speed of the high-speed fluid flow at the output of the fluid flow providing device or the impact velocity the high-speed fluid hitting the filaments is advantageously at least two times, advantageously 3-5 times, or even most advantageously over 5 times the velocity of the transferring speed of the filaments. According to an example, the flow rate of the fluid flow provided by the fluid flow providing device is controllable and the speed of the high-speed fluid flow is at a range of 50-330 m/s, more advantageously 50-200 m/s or 100-150 m/s, whereupon the transferring speed of the filaments by the transferring device in the first direction 107 is typically 10-20 m/s. However, these are only examples, and the invention is not limited to those only, and in some examples, density of the high-speed fluid flow and density of the material the path of which is to be controlled may have an effect for choosing a suitable speed difference for the velocity of the high-speed fluid (and/or the velocity of the transferring speed of the material).

The arrangement may also comprise an air compressing device 116 for providing compressed air 117 to the input 118 of the fluid flow providing device 108.

In addition, the fluid flow providing device 108 may comprise at least one valve 121 or the like for opening and closing a certain portion of the outputs 114 of the fluid flow providing device 108. In addition, according to an embodiment the arrangement may comprises also a manipulator 122 for turning the fluid flow providing device 108 around its axis or move the fluid flow providing device 108 in the first and/or second directions and thereby adjust the fluid flows in a desired manner in relation to the transferring device and/or the filaments transferred.

In addition, the material flow, such as the filaments transferred, is advantageously continuous so when some portion of the material is deflected the rest will easily follow the previous deflected portion of the material.

The invention has been explained above with reference to the aforementioned embodiments, and several advantages of the invention have been demonstrated. It is clear, that even if the pressurised air is mentioned as an example of the high-speed fluid flow, also other types of fluids can be used, such as nitrogen, for example. In addition, even if the filaments are transferred by the belt conveyor, also other types of transferring devices can be used, such as a rolling cylinder.

The features recited in dependent claims are mutually freely combinable unless otherwise explicitly stated.

1. An arrangement for arranging number of filaments transferred by a transferring device to at least two separate subsets of said filaments, wherein said transferring device is configured to receive the filaments to a surface of the transferring device in an input area of the transferring device from multiple outputs and transfer the filaments from the input area to an output area of the transferring device in a first direction and again to a further process,
wherein the arrangement comprises
at least one fluid flow providing device for providing fluid flow towards at least one portion of the filaments transferred by the transferring device thereby deflecting a path of said portion of the filaments in a second direction differing from said first direction, and to separate said portion to a subset from the rest of the filaments and again to provide at least two separate subsets of the filaments.

2. The arrangement of claim 1, wherein the filament subsets are again arranged to at least two separate bundles for said further process of said filaments, wherein said bundles are separately reopenable bundles to a size said bundle was winded.

3. The arrangement of claim 2, wherein the arrangement comprises at least one winding device for winding the bundles of the filaments.

4. The arrangement of claim 1, wherein the arrangement comprises at least two fluid flow providing devices for providing fluid flows towards at least two portions of the filaments transferred by the transferring device and thereby to provide at least three separate subsets of the filaments, and again three separate bundles for said further process of said bundles, wherein said at least two fluid flow providing devices are arranged sequentially in said first direction.

5. The arrangement of claim 1, wherein the arrangement comprises at least two, or as many as the number of the filament subsets collecting devices for collecting and guiding the filament subsets after the fluid flow providing devices to separate said filament subsets to separate bundles for the further process, said further process comprising a winding or folding process.

6. The arrangement of claim 5, wherein the collecting device comprises a pressure manipulating device for decreasing pressure in the collecting device thereby causing a sucking effect separately for each of the separate filament subsets after the fluid flow providing devices

7. The arrangement of claim 6, wherein the pressure manipulating device comprises an ejector.

8. The arrangement of claim 1, wherein the arrangement comprises at least 300 outputs, said outputs comprising. nozzles, to provide essentially as many filaments, and wherein the fluid flow providing device is configured to arrange number of portions of said filaments to number of the filament subsets so that at least one filament subset and thus at least one bundle has less than 300 filaments or 100 filaments at maximum.

9. The arrangement of claim 1, wherein the fluid flow providing device comprises an input for receiving fluid flow and number of outputs for providing and focusing number of high-speed fluid flows towards the filaments transferred, wherein speed of the high-speed fluid flow is configured to be higher than a transferring speed of the material, whereupon a velocity gradient of the high-speed fluid flow is configured to induce a dragging force dragging the filaments towards a maximum of said velocity gradient and thereby changing the path of the filaments.

10. The arrangement of claim 1, wherein at least one fluid flow providing device is arranged between said input and output areas.

11. The arrangement of claim 1, wherein the fluid flow providing device is a fluid conduit, having number of outputs along said fluid conduit.

12. The arrangement of claim 9, wherein the output of the fluid flow providing device comprises a nozzle, or a compressed air nozzle.

13. The arrangement of claim 9, wherein the arrangement comprises outputs with different diameters, where the smaller diameter outputs are arranged in a downstream in the direction of the travel of the transferring device and the greater diameter outputs are arranged in an upstream in the direction of the travel of the transferring device.

14. The arrangement of claim 1, wherein the arrangement comprises an air compressing device for providing compressed air to the input of the fluid flow providing device.

15. A method for arranging number of filaments transferred by a transferring device to at least two separate subsets of said filaments,
wherein the method comprises steps of:
receiving filaments to a surface of the transferring device in an input area of the transferring device from multiple outputs and transferring the filaments from the input area to an output area of the transferring device in a first direction and again to a further process, and
providing fluid flow towards at least one portion of the filaments transferred by the transferring device, thereby deflecting a path of said portion of the filaments in a second direction differing from said first direction and separating said portion to a filament subset from the rest of the filaments and again providing at least two separate filament subsets of the filaments.

16. The method of claim 15, wherein said filament subsets are separated again at least two separate bundles for said further process of said filaments, wherein said bundles are separately reopenable bundles.

17. The method of claim 15 or 16, wherein a flow rate of the fluid flow provided by the fluid flow providing device is controlled and wherein the speed of the fluid flow is 50-330 m/s.

18. The method of claim 16, wherein the filament subsets and again the bundles are made from continuous filaments.
